(19) United States
(12) Patent Application Publication
(10) Pub. No.: US 2004/0068811 A1
(43) Pub. Date: Apr. 15, 2004

(54) Manual and electronic orthodontic toothbrushes

(76) Inventors: Jacqueline Fulop, New York, NY (US); Sonia Mota-Lopez, East Meadow, NY (US); Julia Trigg Cuccaro, Lindenhurst, NY (US)

Correspondence Address: ALFRED M. WALKER, 225 OLD COUNTRY ROAD, MELVILLE, NY, 11747-2712, US

(21) Appl. No.: 10/464,077

(22) Filed: Jun. 18, 2003

Related U.S. Application Data
(63) Continuation-in-part of application No. 09/907,461, filed on Jul. 17, 2001, now abandoned.
Application No. 09/907,461 is a continuation of application No. 09/655,015, filed on Sep. 5, 2000, now Pat. No. 6,260,227.
Application No. 09/655,015 is a continuation-in-part of application No. 09/224,468, filed on Dec. 31, 1998, now abandoned.

(51) Int. Cl. A61C 17/34

(52) U.S. Cl. 15/22.2; 15/22.4; 15/22.1

(57) ABSTRACT

An orthodontic toothbrush cleans braces and teeth effectively, including braces which have brackets protruding from tooth surfaces, wherein the brackets are connected by a spanning archwire. The orthodontic toothbrush has a longitudinally extending handle for manual use, or an optional plastic electric battery operated body, attached to a toothbrush head. The bristle head includes rows of bristles, which contact and clean both the orthodontic appliances attached to the surfaces of the teeth and underlying teeth. The height of the shortest group of bristles in the middle of all the bristle rows, represents an average protrusive depth of a typical bracket or band protruding from a tooth's surface. An intermediate row of bristles, bilaterally, is used to assist in cleaning the incisal/occlusal (top) and gingival (bottom) portions of a tooth's crown and orthodontic bracket or band. Adjacent to the intermediate heighted bristles are rows of pairs of tufts of taller bristles that split apart, bilaterally to reach between surfaces. The tallest bristles are located at the distal end of the toothbrush head.

### RELATED APPLICATIONS

This application is a continuation-in-part of application Ser. No. 09/907,461, filed Jul. 17, 2001, which application is continuation of application Ser. No. 09/655,015, filed Sep. 5, 2000, now U.S. Pat. No. 6,260,227, which was a continuation-in-part of application Ser. No. 09/224,468, filed Dec. 31, 1998.

### FIELD OF THE INVENTION

The present invention relates to electronic or manually operable toothbrushes for cleaning hard to reach tooth surfaces in compliance with orthodontic treatment. It is designed to brush and clean braces and the underlying teeth, simultaneously.

### BACKGROUND OF THE INVENTION

Toothbrushes for children, adolescents and adults with braces are generally scarce. A special toothbrush must be used for cleaning braces and teeth, since unlike unadorned teeth with flush generally flat faces with rounded edges, braces have a bracket or band which protrudes from the flat surface of a tooth. Square or rectangular shaped braces attached to the front or back surfaces of a tooth are called brackets. Round shaped braces fitting around a tooth, usually in the posterior section of the oral cavity, are called bands. An orthodontic archwire is placed into the brackets and bands and held in by ligature ties or connectors. Since an archwire spans from tooth to tooth, food and debris accumulate interproximally, below the orthodontic bands, brackets and archwires, where food debris and bacteria tend to harbor. These are areas which are difficult to reach with a conventional toothbrush.

Relevant prior art includes U.S. Pat. No. 4,033,008 of Warren, which shows a bristle head with a taller distal set of bristles. U.S. Pat. No. 4,382,309 of Collis, U.S. Pat. No. 4,706,322 of Nicholas, U.S. Pat. No. 5,325,560 of Pavone and U.S. Pat. No. 3,678,528 of Haije all show toothbrushes where outer bristles are higher than inside bristles. U.S. Pat. No. 5,628,082 of Moscovich shows a toothbrush with stepped rows of higher and lower bristles. But, these are discrete clumps, not tapered pairs as in the present invention.

Another relevant patent is U.S. Pat. No. 1,018,927 by Sarrazin which has the tallest bristles being rounded bunched bristle tufts. These bristles do not merge to a point. However, having bristles merge to a point is necessary to clean several areas for patients in orthodontic treatment, in order to clean bacterial debris in the distal regions of the most posterior teeth in the mouth, along with point contact above (incisal or occlusal) and below (gingival) to the archwire of braces of a patient in orthodontic treatment. It is impossible to clean the bacterial debris in these areas with the rounded bunched bristle tufts portrayed in FIG. 4 of Sarrazin '927 patent since the rounded tufts of bristles cannot fit between the close proximity of the orthodontics brackets on the teeth.

Also in Sarrazin '927, the outer bunched bristles in FIG. 2 therein are one unitary set of bristles coming to a peaked point. Furthermore, lines 64-66 therein state that the tufts should be spaced to get between the teeth.

Therefore, Sarrazin '927 does not have pairs of outer tufts created by the convergence of two separable and distinct tufts, as proposed in the present orthodontic toothbrush of the invention, which creates a tapered point by an oblique angulation of each tip of each pair of tufts in opposite directions. In contrast to Sarrazin '927, the bristles of the orthodontic toothbrush of the present invention sweep to remove debris on a mesial or distal surface of a tooth, and they can penetrate a greater distance interproximally between the teeth.

Furthermore, groove “c”, as shown in FIG. 1 of Sarrazin '927 and described in lines 86-91 therein, was fabricated to help placement of the brush by the patient on the tables (occlusal portion) of certain posterior teeth. In contrast, the shorter bristles in the center of the orthodontic toothbrush present invention are so that a patient's braces and teeth can be reached and cleaned simultaneously, on the facial surface (the surface one can see when a patient is smiling) or lingual surface (the tongue side). Unlike the brush of Sarrazin '927, the orthodontic toothbrush of the present invention help cleans either the facial or lingual surface, dependent upon where the braces are placed-on the inside or outside surfaces of the teeth.

In addition, lines 48-59 and 101-104 of Sarrazin '927 state that Sarrazin's toothbrush requires less bristle rows in the front of the brush than in the rear of it, in a transversely extending direction throughout the toothbrush. In contrast, in the orthodontic toothbrush, of the present invention, there are the same number of rows transversally throughout the toothbrush. This is necessary since braces are placed in the front (anterior) and rear (posterior) sections of the mouth, in the majority of orthodontic cases.

Moreover, U.S. Pat. No. 5,472,972 of Bredall is similar to toothbrush of the aforementioned Warren '008 patent in which all the bristles are flat and do not come to a point, as do the separable pairs of tufts of bristles of the present invention.

Neither Sarrazin '927 nor Bredall '972, either singularly or in combination describe or suggest an orthodontic toothbrush with one large peaked tuft of bristles, and with a gently curving inner surface sloping up from shortest bristles, to medial sized bristles, to taller bristles, wherein the bristles are arranged in adjacent pairs of tufts, wherein further each tuft has oblique distal surfaces that form a split peak when adjacent to each other.

Moreover, the crevice gaps between each tuft of the pairs of tufts of the orthodontic toothbrush of the present invention enable the peaked pairs of tufts to split apart from each other and diverge at the peak, a feature impossible to be accomplished with unitary tufts of Sarrazin '927 or Bredall '972.

Furthermore, the prior art patents do not assert that they are or can be utilized for teeth undergoing orthodontic construction.

To clean orthodontic braces and the teeth to which they are attached, requires a special configuration of pairs of tufts at varying heights, wherein two adjacent pairs of tufts together form a peak separable by a gap between each tuft of each pair of tufts, to maximize both reach and divergence of the cleaning surfaces of the tooth brush upon the respective braces and underlying teeth.

Electronic toothbrushes which move bristles by electrically powered mechanical motion are known. For example, For example, U.S. Pat. No. 3,160,902 of Aymar shows an electronically operated toothbrush with a back and forth, axially movable bristle head.

U.S. Pat. No. 4,995,131 of Takeda shows an electronic toothbrush with a dipping, oscillatory pivot off of the axis of the toothbrush.

U.S. Pat. No. 5,822,821 of Sham shows an electronic toothbrush with an oscillation motion rotating off of the axis (sweeping left and right when viewing the axis head on from the front).

U.S. Pat. No. 6,230,717 of Marx is a disposable electronic toothbrush with a rotating bristle head.

However, the prior art does not describe an electronic toothbrush with a vibrating or other directional motion, wherein the bristle head of an electronic toothbrush can help utilize this style of bristles in an oscillatory, rotating, stroke-like or vibrating motion to remove debris around the orthodontic braces, including brackets and bands, and the teeth.

Non-patented prior art includes a ORAL B orthodontic toothbrush of Oral B Laboratories of Belmont, Calif. which is similar to the Collis '309, Nicholas '322, Pavone '560 and Haije '528 patents. The COLGATE TOTAL toothbrush of Colgate-Palmolive Co. of Canton, Mass. is like the brush of Moskovich '082 patents which has stepped rows of higher and lower bristles. But these also are discrete clumps, not tapered pairs with a rippled zigzag configuration as in the present invention.

Tapered pairs with a rippled zigzag configuration are shown in the CREST COMPLETE toothbrush of Proctor and Gamble Co. of Cincinnati, Ohio.

However, none of the prior art toothbrushes provide a toothbrush, which acts to effectively clean the teeth and orthodontic braces of a child, adolescent or adult under orthodontic treatment.

### OBJECTS OF THE INVENTION

It therefore is an object of the present invention to provide a toothbrush for children, adolescents and adults with braces.

It is also an object of the present invention to provide a disposable or permanent electronic orthodontic toothbrush, with a uniquely shaped bristle head configuration, for children, adolescents and adults with braces.

It is further an object of the present invention to provide an electronic orthodontic toothbrush which can provide a variety of directional motion from interchangeable bristle heads, or in a bristle head with a combination of rotational and back and forth stroking motions.

It is yet another object to provide an electronic toothbrush which can convert rotary motion to linear motion and vice versa.

It is also an object to provide a toothbrush, which can help dislodge oral debris and bacteria by bracing the brackets, bands, archwires and ligature connectors, while simultaneously reaching the teeth, without impinging upon and harming any of the gingival surfaces.

It is also an object to provide a toothbrush, which can clean coronal (top) or apical (bottom) surfaces of a tooth's crown, with an orthodontic bracket or band attachment, in the anterior and posterior regions of the mouth.

It is also an object to provide a toothbrush, which can clean around the coronal (top), apical (bottom) and distal (backside) portions of an orthodontic band, with or without attachments, in the posterior region of the mouth.

It is also an object to provide a toothbrush, which can clean interproximally, between the teeth, and underneath the archwire, in the anterior and posterior regions of the mouth.

It is also an object to provide a toothbrush, which can assist in getting angular brush access to the mesial (toward the facial midline) and distal (away from the facial midline) surfaces of a bracket or band in the anterior and posterior regions of the mouth.

It is further an object to improve over the disadvantages of the prior art.

### SUMMARY OF THE INVENTION

The terminology for the following section on bristles is as follows: “shortest” is defined as those bristles bundles in a middle row of the bristle head; “intermediate” is defined as those bristles bundles in single rows adjacent to each side of the shortest row; “taller” is defined as those bristles as the two single most outer, lateral, rows; and, “tallest” is defined as the most distal and tallest bristles on the toothbrush head.

In keeping with these objects and others, which may become apparent, the present invention is a toothbrush for children, adolescents and adults with braces. A special toothbrush must be used for cleaning braces and teeth, since unlike unadorned teeth with flush, generally flat faces, with rounded edges, braces have brackets and/or bands which protrude from the surface of a tooth, wherein the brackets are connected by a spanning archwire.

Therefore, the bristle head of the present invention includes a plurality of rows of bristles designed to contact and brush both the protruding brackets and underlying teeth at the same time.

Briefly, the brush includes a handle which can be operated manually or electronically with optional interchangeable pointed rubber, bristle and gingivally stimulative extensions in different shapes or forms, to clean between the teeth at one proximal end of the toothbrush, with a bristle head at the other, distal end.

The shortest and intermediate bristles—in height can dislodge food and debris from the bracket while the intermediate, taller and tallest bristle heights can dislodge food and debris simultaneously from the different crevices and areas of the teeth.

When viewed in a cross section from the handle's end, the shortest group of bristles is in the middle of all the bristle rows. The height of these shortest bristles represents an average protrusive depth of the thickness of a typical bracket or band protruding from a tooth's surface. The shortest bristles help clean the debris from the irregularities within the brackets and bands, where bacteria tend to harbor.

The following are average bracket depths, defined as labiolingual thickness, courtesy of Rocky Mountain Orthodontics and GAC International: RMO SYNERGY Bracket 1.6-2.2 mm, RMO MINI TAURUS Bracket 1.6-2.3 mm, GAC OVATION Bracket 1.3-1.9 mm, GAC MICROARCH bracket 1.3-1.85 mm, GAC OMNIARCH Bracket 1.45-1.7 mm, GAC ALLURE bracket 1.6-2.1 mm, GAC ELAN bracket 1.8-1.9 mm and GAC band depths are an average of 3.65 mm with triple tube attachments.

Laterally are two intermediate groups of bristles which slope outwardly upward, producing a concavity, to encompass a bracket or band. The intermediate height bristles are utilized to assist in removing and cleaning food debris and bacteria harboring on the incisal/occlusal (top) and gingival (bottom) portions of a tooth's crown and orthodontic bracket or band.

At the most lateral or outer edges is a pair of taller bristles, also with sloped surfaces extending outwardly upward, enabling the bristles to remove the bacteria harboring on the incisal or occlusal (top) and gingival (bottom) portion of a tooth's crown or orthodontic attachment.

When viewed laterally, from the side, the bristles include pairs of bristles each having slanted surfaces extending toward a middle high point. This creates V-shaped recesses between adjacent pairs of bristles. Furthermore, the tallest bristles at the distal end of the toothbrush's head can be viewed. The tallest bristles are utilized to clean interproximally, between the teeth and at the mesial and distal portions of a tooth's surface of a bracket or band, in the anterior or posterior regions of the mouth.

The tallest bristles blend in a concavity toward the tallest distal set of bristles to assist in getting brush access to an orthodontic band's attachments in the posterior region of the mouth.

By the above configuration the user can brush around all sides of each bracket and band, as well as underneath the spanning archwire and all surfaces of a tooth.

The preferred embodiment of the present invention includes an orthodontic toothbrush for cleaning braces, including brackets and bands, which are adhered to teeth, while the brush is simultaneously used for cleaning the teeth. For example, the orthodontic toothbrush of the present invention is used where each tooth has a bracket or band which protrudes from the surface of a tooth, and wherein each bracket and band is connected by a spanning archwire.

The toothbrush has a longitudinally extending manually or electronically operated handle attached to a tooth cleaning head having a plurality of bristles extending upward from a bottom within the bristle head to a top thereof.

In contrast to the prior art and in furthermore of the objects of the present invention, the orthodontic toothbrush of the present invention has a plurality of adjacent pairs of tufts of bristles extending upwardly from the bristle head in a plurality of longitudinally disposed rows. These tufts have bristles projecting upward parallel to one another wherein the tufts of bristles respectively contact adjacent tufts, along the entire length of the tufts from bottom to top.

The plurality of pairs of adjacent tufts form a mass of parallel bristles, each tuft being a solid, unbroken un-spaced mass extending from the bristle head upward to the tops of the respective bristles of the tufts.

Each tuft has bristles having top-to-bottom lengths, which varying to form a contoured tooth contact surface, formed by the tops of the plurality of respective bristles.

Except for the smallest tufts in the middle of the bristles, and the singular large tuft at the distal end, preferably these tufts are discrete separable aggregate pairs of bristles, separated by gaps, splitting upon pressure from contact with teeth between respective adjacent pairs of tufts, wherein the tuft gaps split and run vertically along the top-to-bottom length of the adjacent pairs of tufts. These split-apart tuft pairs have bristles urged into varying directions according to each tuft by pressure of their contact with teeth, so that the bristles of differing tufts are being separately and differentially inserted into the gaps between teeth and into the spaces between the orthodontic brackets and tooth surfaces.

The contoured tooth contact surface also forms a depressed center of inner rows of tufts disposed on the bristle head, wherein the inner bristles are the relatively shortest bristles.

The contoured tooth contact surface also has upwardly and outwardly sloped medial rows of tufts disposed on the bristle head, which are relatively longer than the shortest inner bristles. These medial rows of tufts are disposed laterally outward on both sides of the inner rows of tufts.

Furthermore, the contoured tooth contact surface has an elevated perimeter of outer rows of tufts disposed on the bristle head, which outer bristles are relatively taller bristles.

The inner rows of tufts have a plurality of tooth contact surface facets, corresponding to individual tufts and the facets form an inner portion of the contoured tooth contact surface.

These inner rows form a tooth contact surface sloping gently upward from a center toward the outer rows of tufts.

The outer perimeter pairs of tufts form a tooth contact surface with a plurality of peaks, of separable pairs of adjacent perimeter tufts having top tooth contact surfaces sloping downwardly away from the point of mutual tuft pair contact.

These peaked pairs of tufts are separable in a gap splitting and running vertically along the top-to-bottom length of the adjacent pairs of tufts, wherein each respective peak when contacted by teeth, includes tuft pairs which are separately and differentially insertable into gaps between teeth and into spaces between orthodontic brackets and tooth surfaces.

At a distal end, the bristle head has at least one distal tuft which is preferably from about 10% to about 20% taller than the perimeter, medial and inner tufts in contact with the distal tuft, to assist in getting brush access to the band attachments and brace fasteners in the posterior region of the mouth.

This distal tuft has a tooth contact surface with oblique angulation extending in opposite directions, in an upwardly facing point.

The toothbrush cleans interproximally beneath the spanning archwire, and the mesial and distal tooth and bracket or band surfaces, in the anterior and posterior regions of the mouth.

The height of the shortest-bristle inner tuft rows represents the average protrusive depth of the thickness of each bracket protruding from each tooth surface.

At the distal end of the bristle head the tallest bristles are used to clean from around each coronal crown end of each tooth to each apical gum end of each tooth at the rear posterior portions of the mouth.

The orthodontic toothbrush of the present invention cleans orthodontic braces and the teeth to which they are attached, with the aforementioned special configuration of pairs of tufts at varying heights, wherein two adjacent pairs of tufts together form a peak separable by a gap between each tuft of each pair of tufts, to maximize both reach and divergence of the cleaning surfaces of the tooth brush upon the respective braces and underlying teeth.

For example, an optional embodiment for an electronic toothbrush operates movement of the bristle head with a vibrating or other directional motion, wherein the bristle head of an electronic toothbrush can help utilize this style of bristles in an oscillatory, rotating, stroke-like or vibrating motion to remove debris around the orthodontic braces, including brackets and bands, and the teeth.

The electronic toothbrush embodiment includes a handle housing containing the motor, mechanisms, power source and electronics. A brush head with bristles is connected to the handle housing by a switch and a mechanical coupling collar that locks the bristle head to the handle housing.

While the power source may be removable or rechargeable batteries, in an alternate embodiment it can be a large capacity lithium battery located with a disposable sealed housing.

Three distinctly different oscillatory motions are supported by this electronic toothbrush simply by changing head assemblies engagable with the universal handle housing. For example, the bristle head can move in an axially oscillating direction, sweeping in an arc.

In another embodiment, the bristle head can tilt in a pivoting oscillatory motion.

In a further embodiment, the bristle head can move in an up and down, back and forth axial stroke direction.

Each of the different motions is conducted by specific mechanisms within each bristle head, which are connectable to the handle housing containing the power supply and motor. All three motions are derived by mechanisms in the respective bristle heads, which convert the reciprocating motion derived from the common drive motor within the handle housing.

While other motors may be used, in a preferred embodiment a rotary permanent magnet DC motor has an output shaft engagable with a speed reducing drive, to convert rotary motion to reciprocating motion of the output shaft.

To achieve sweeping axial brush head oscillations, it includes a partial turn assembly such that linear movement of the shaft and an attached piston causes the bristle head to rotate in an oscillatory motion by virtue of a pin sliding in spiral slots.

For the tilting version where the bristle head tilts by pivoting oscillations, a piston is attached to a semi-flexible member which causes oscillatory tilting of the bristle head by acting in a push-pull movement when the shaft is subject to linear oscillation.

For the back and forth stroke movement, the internal mechanisms impart linear oscillatory strokes to the bristle head, which are extended to the bristle head by a piston-type mechanism.

The electrical circuitry includes a power source, such as a replaceable, rechargeable or single use large capacity battery which supplies electrical power to a speed control which drives the speed controlled motor.

In an alternate embodiment, an actuator can permit smooth operation over a very wide range of oscillatory frequencies, since no conversion from rotary to reciprocating motion is required. Varying the oscillator frequency is directly translated into reciprocating motion of the output shaft controlling the various directional motions of the different bristle heads.

In yet another embodiment, a head assembly can support a compound motion with rotary motion and linear stroking motion. In this embodiment, the bristle head assembly is modified wherein a cylinder is constrained in linear stroking motion relative to a coupling sleeve with spaced distance ridges. In that case, the bristle head can stroke linearly for part of the stroke then rotate in one direction, then on the reverse stroke, the bristle head can stroke linearly in the opposite direction and then rotate in a reverse direction.

Other options include having a gripping surface like the handle part of the CREST COMPLETE or CREST SPINBRUSH toothbrushes, as well as optional interchangeable heads, so that one can take off the brace modified bristle head for a conventional head for the lingual tongue side of teeth without brackets, as well as some kind of joint to set the orientation of the toothbrush head at 45 degrees in conjunction with the American Dental Association's recommendation of brushing utilizing the Modified Bass Technique.

### BRIEF DESCRIPTION OF THE DRAWINGS

The present invention can best be understood in connection with the accompanying drawings in which:

FIG. 1 is a left side perspective detail of an orthodontic toothbrush of this present invention;

FIG. 1A is a right side perspective view thereof;

FIG. 1B is a front view thereof;

FIG. 1C is a rear view detail of the bristle portion thereof;

FIG. 1D is a right side elevational detail view thereof;

FIG. 2 is a perspective side view of the toothbrush in use;

FIG. 3 is a perspective distal end view of the toothbrush in use;

FIG. 3A is a perspective view of the toothbrush in use, showing the divergence of adjacent tufts of pairs of tufts upon contact with teeth and orthodontic surfaces;

FIG. 3B is a front elevational view of the toothbrush as in FIG. 3A in use;

FIG. 3C is a rear cross-sectional view thereof;

FIG. 4 is a side view detail of the handle end thereof with a flexible gingival stimulator thereon;

FIG. 4A is a top plan view of the handle as in FIG. 4, without a stimulator attached;

FIG. 4B is a perspective view thereof, with the stimulator attached;

FIG. 4C is a front elevational view of the stimulator as in FIG. 4B; thereto;

FIG. 5 is a side view of the gingival stimulator in use;

FIG. 6 is a side view detail of the handle end of the toothbrush with conical bristles thereon;

FIG. 6A is a top plan view of the handle as in FIG. 4, without a stimulator attached;

FIG. 6B is a perspective view thereof with the stimulator attached;

FIG. 6C is a perspective view thereof with the stimulator attached;

FIG. 7 is a side view of the conical brush in use;

FIG. 8 is a side view detail of a removable adjustable bristle head for the toothbrush;

FIG. 9 is a distal end view detail of the removable adjustable bristle head;

FIG. 9A is perspective view of a toothbrush with the removable head as in FIGS. 8 and 9;

FIG. 9B is a top plan view thereof;

FIG. 9C is a left side view thereof; shown upside down;

FIG. 9D is a right side elevational view thereof;

FIG. 9E is a perspective view thereof;

FIG. 10 is a distal end view of the toothbrush with a removable adjustable bristle head, illustrated at three permissible positions, preferably vertical and two angled at 45 degrees;

FIG. 11 is an alternate embodiment side view detail of a toothbrush with a curved bristle head;

FIG. 12 is a perspective view if an optional embodiment for an electronically operated orthodontic toothbrush;

FIG. 13 is a close-up perspective view of the bristle head portion of the electronically operated orthodontic toothbrush as in FIG. 12;

FIG. 14 is a distal end schematic view for an axially oscillating version thereof, rotatably pivoting about the axis;

FIG. 15 is a side schematic view for a pivoting oscillatory version thereof;

FIG. 16 is a side schematic view for an axial stroke moving version thereof;

FIG. 17 is a top view of a rotary to reciprocating mechanism for the electronically operated toothbrushes of this invention;

FIG. 18 is a cross sectional side view of the head assembly for an axially oscillating version thereof;

FIG. 19 is a cross sectional side view of the head assembly for a pivoting oscillatory version thereof;

FIG. 20 is a cross sectional side view of the head assembly for an axial stroke moving version thereof; and,

FIG. 21 is an electrical block diagram for a motor driven electronic toothbrush of this invention; and,

FIG. 22 is an electrical block diagram for an alternate embodiment for an electronic toothbrush of this invention driven by a voice coil actuator.

### DETAILED DESCRIPTION OF THE INVENTION

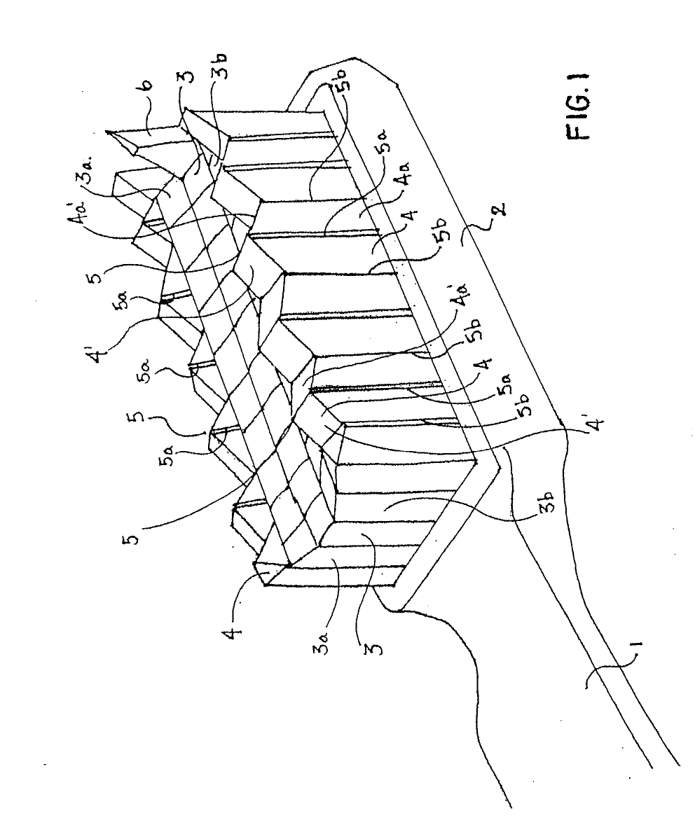

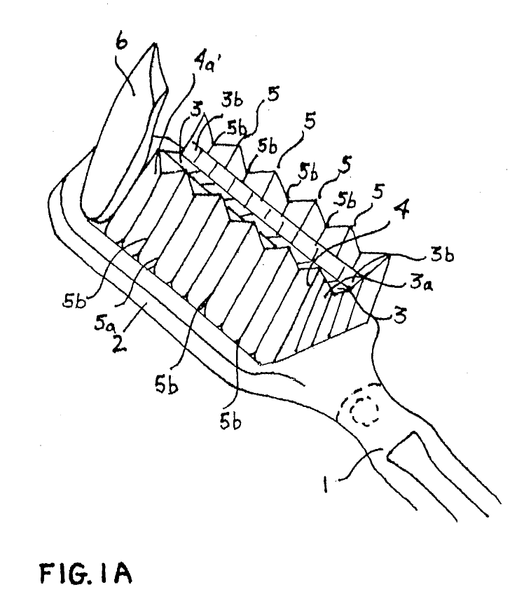

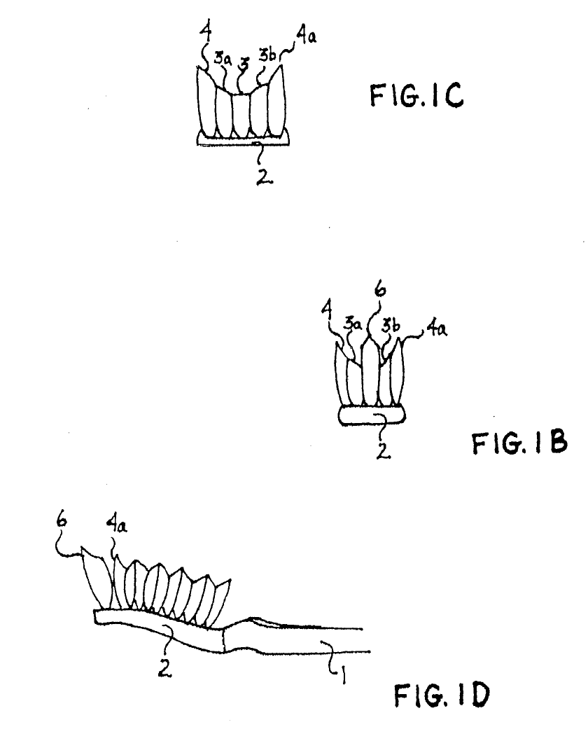

FIGS. 1, 1A, 1B, 1C and 1D show an enlarged view of the bristle head 2 of this invention. This is attached to toothbrush handle 1 having friction inducing gripping surface 1a thereon and shows several features. The medial bristle bundles 3 are the shortest. The bristle bundles 3a, 3b on either side slope outward to form a concavity. At the outer edges, pairs of taller bristle bundles 4, 4a also have sloped surfaces extending outwardly. One or more tallest bristle bundles 6 at the distal end are used to clean around the inner teeth at the ends of the rows. When viewed laterally, pairs of bristle bundles 4, 4a extend to a point such as denoted by 5 to create wedges to gain access interproximally between two adjacent teeth.

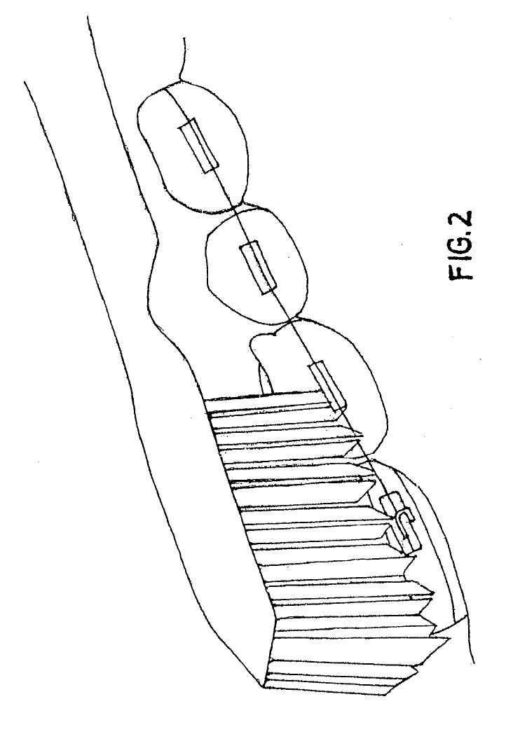

FIG. 2 shows the cleaning method by tallest peaked bristle bundle 6 at the end of a row of teeth 14. The wire 13 is anchored at joint 11 to orthodontic band 10 and rides on brackets 12. This view of FIG. 2 shows the use of the brush as applied to dentition on the posterior region.

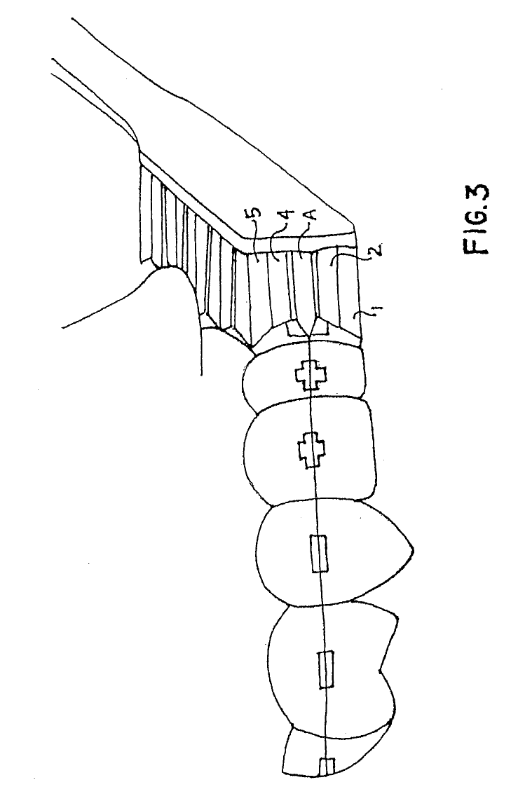

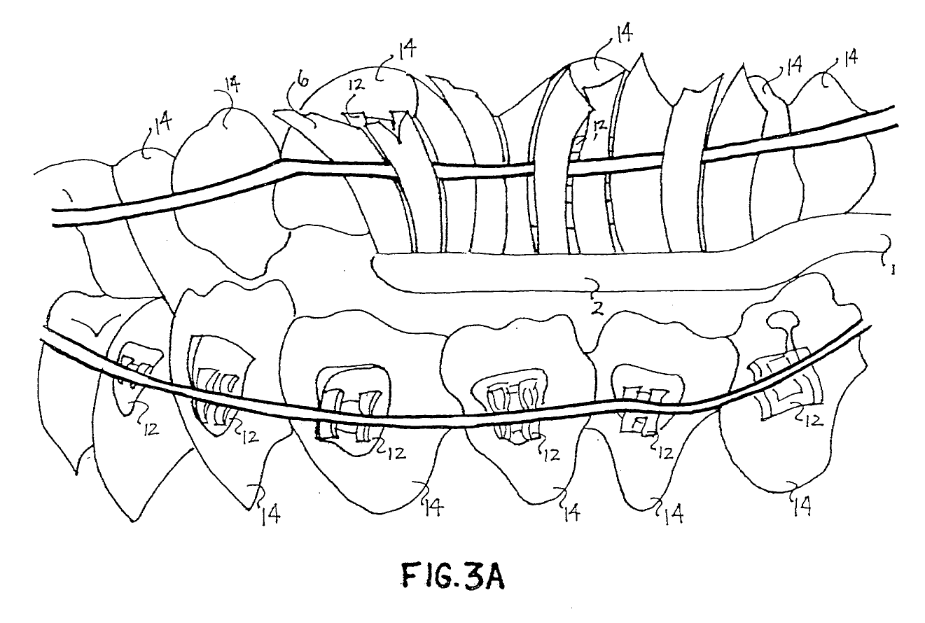

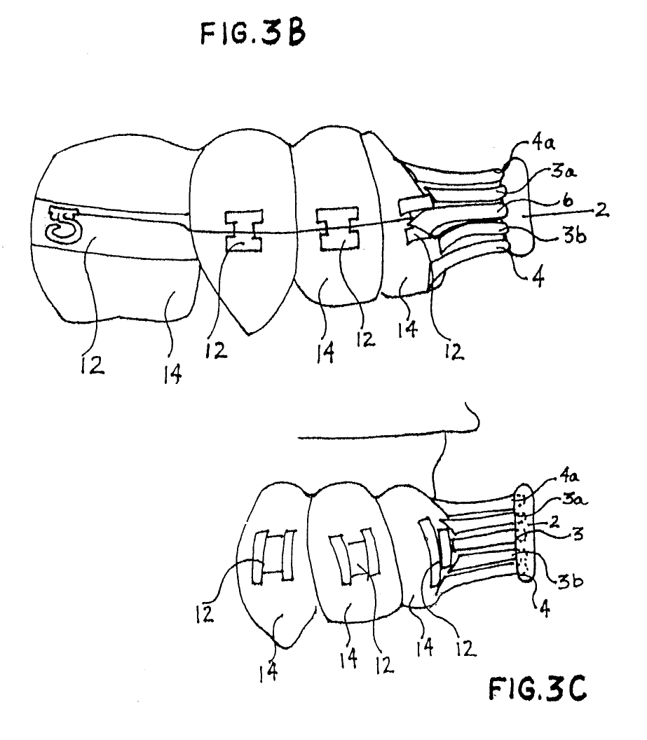

FIG. 3 is a right anterior view showing the end of bristle head 2 applied to dentition, showing the preferred fit of the bristle end contour.

FIGS. 1, 2, 3, 3A, 3B and 3C also show that toothbrush 1 includes a plurality of adjacent pairs of tufts 4, 4a of bristles extending upwardly from bristle head 2 in a plurality of longitudinally disposed rows, wherein pairs of tufts 4, 4a have groups of bristles projecting upward parallel to one another.

The pairs of tufts 4, 4a of bristles respectively contact respective adjacent tufts 4, 4a along the entire length of tufts 4, 4a from proximal bottom end at bristle head 2 to respective distal top surfaces 4′, 4a′.

The plurality of adjacent tufts 4, 4a each have a mass of parallel bristles, with each bristle mass including a solid, unbroken un-spaced mass extending upward from bristle head 2 to the respective top surfaces 4′, 4a′ of each respective tuft pair 4, 4a of bristles. The pairs of tufts 4, 4a have bristles having top-to-bottom lengths, with the lengths varying to comprise respective contoured tooth contact surfaces 4′, 4a′. Each tooth contact surface 4′, 4a′ is at the peaked distal tops 5 of the plurality of respective pairs of tufts 4, 4a of bristles.

Each of the tufts 4, 4a are discrete separable aggregates of bristles separated by linearly extending gaps 5a, and contact surfaces 5b, wherein the respective pairs of tufts 4, 4a are separable into split pairs of tufts 4, 4a upon pressure from contact with teeth 14 between respective adjacent pairs of tufts 4, 4a. The tuft gaps 5a, [5b] run vertically along the top-to-bottom length of the adjacent pairs of tufts 4, 4a, wherein the pairs of tufts 4, 4a are split-apart and urged into varying directions according to each tuft 4, 4a by pressure of contact with teeth 14. The bristles of differing pairs of tufts 4, 4a are separately and differentially insertable into gaps between surfaces of teeth 14 and into spaces between orthodontic brackets 12 and wires 13.

The medial contoured tooth contact surface is a depressed center of inner rows of shorter tufts 3 located on bristle head 2, wherein the tufts 3 of inner bristles are relatively shortest bristles.

Between shortest tufts 3 and taller pairs of tufts 4, 4a are upwardly and outwardly sloped medial rows of tufts 3a, 3b attached to bristle head 2, wherein these medial bristles of tufts 3a, 3b have bristles relatively longer than the shortest inner bristles of shortest tufts 3, but the medial rows of pairs of tufts 3a, 3b are located laterally outward on both sides of the inner rows of shortest tufts 3.

The contoured tooth contact surface has at an elevated perimeter the pairs of outer rows of tufts 4, 4a located on the outer sides of bristle head 2, wherein the outer tufts 4, 4a of bristles are relatively taller bristles than medial tufts 3a, 3b or inner tufts 3.

The top 4′, 4a′ of rows of tufts 4, 4a are a plurality of angled tooth contact surface facets.

The inner rows of shortest tufts 3 and medial tufts 3a, 3b become a tooth contact surface sloping gently upward from a center at shortest tufts 3 toward the outer rows of pairs of tufts 4, 4a on the perimeter of toothbrush head 2. These perimeter pairs of tufts 4, 4a have a pair of tooth contact top surfaces 4′, 4a′ extending together to form a plurality of peaks 5 separated by gaps 5a. The peaks 5 of pairs of tufts 4, 4a slope downwardly away from the highest point 5 of mutual tuft pair contact, and the peaked pairs of tufts 4, 4a are separable by gaps 5a forming respective splits running vertically along the top-to-bottom length of the adjacent pairs of tufts 4, 4a. The respective tufts 4, 4a are separately and differentially insertable into gaps between teeth 14 and into spaces between orthodontic brackets 12 and wires 13 and adjacent tooth surfaces.

Moreover, bristle head 2 has a distal end having at least one distal peaked tuft 6 therein, wherein distal tuft 6 is preferably from about 10% to about 20% taller than the perimeter pairs of tufts 4, 4a in contact with distal tuft 6 to assist in getting brush access to the band attachments and brace fasteners in the posterior region of the mouth.

The peaked distal tuft 6 forms a tooth contact surface having oblique angulation in opposite directions further forming an upwardly facing point.

Therefore toothbrush 1 is for cleaning interproximally beneath the spanning archwire, and the mesial and distal tooth and bracket or band surfaces, in the anterior and posterior regions of the mouth.

The height of the shortest-bristle inner rows of tufts 3 represents the average protrusive depth of the thickness of each bracket 12 protruding from each tooth surface.

At the distal end of the bristle head 2 the tallest tuft 6 of bristles is used to clean from around each coronal crown end of each tooth 14 to each apical gum end of each tooth 14 at the rear posterior portions of the mouth.

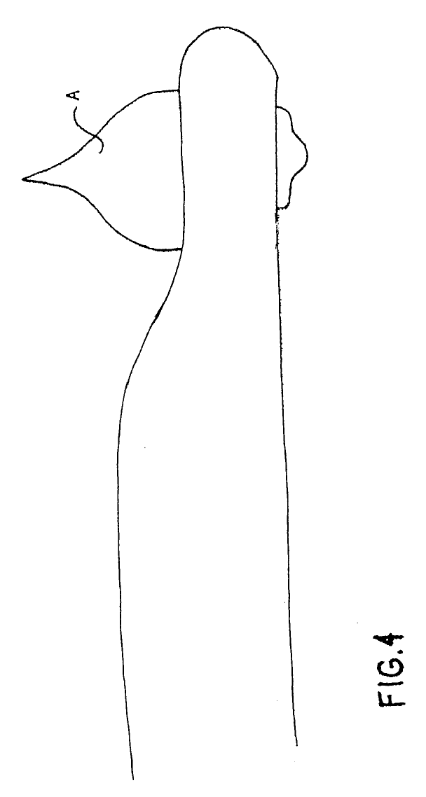

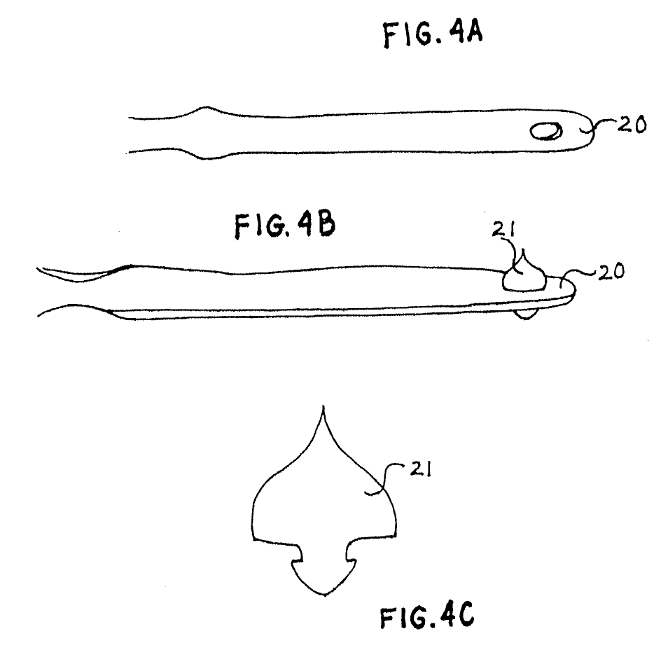

FIGS. 4,4A, 4B and 4C, show a flexible gingival stimulator 21, such as of rubber or other suitable material, attached to a handle 1 at extension 20.

The cleaning technique with the gingival stimulator is illustrated in FIG. 5.

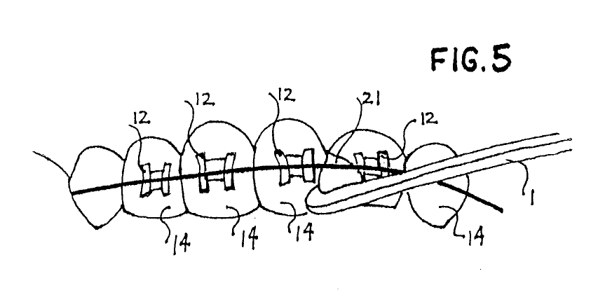

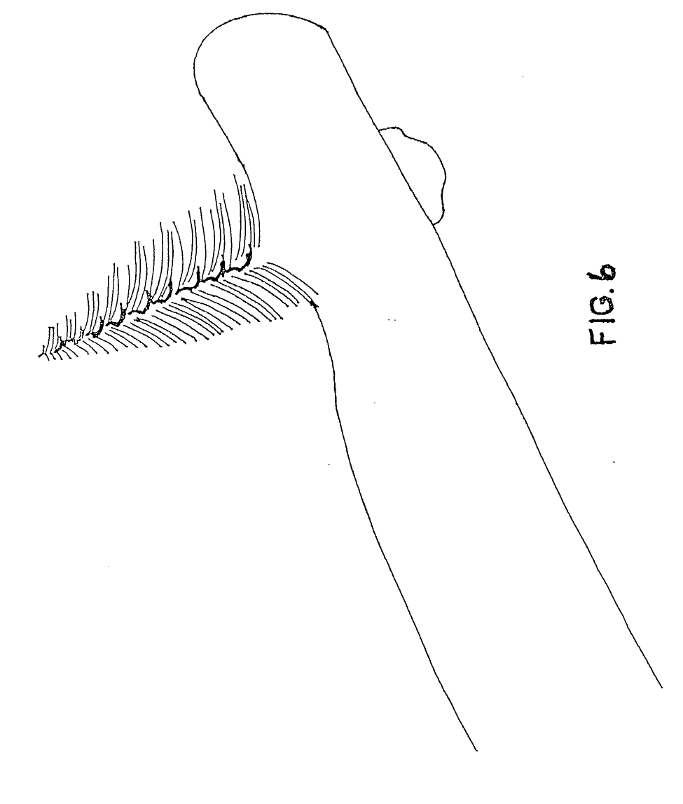

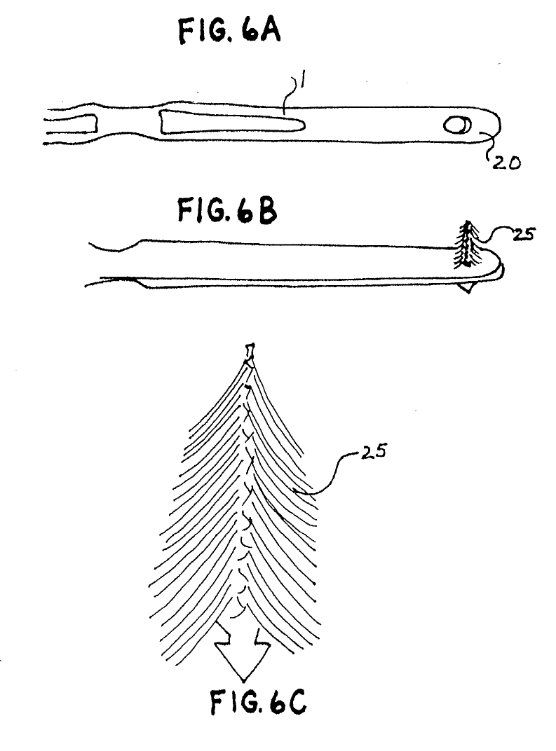

FIGS. 6, 6A, 6B, and 6C show a conical brush 25 attached to handle 1 at extension 20.

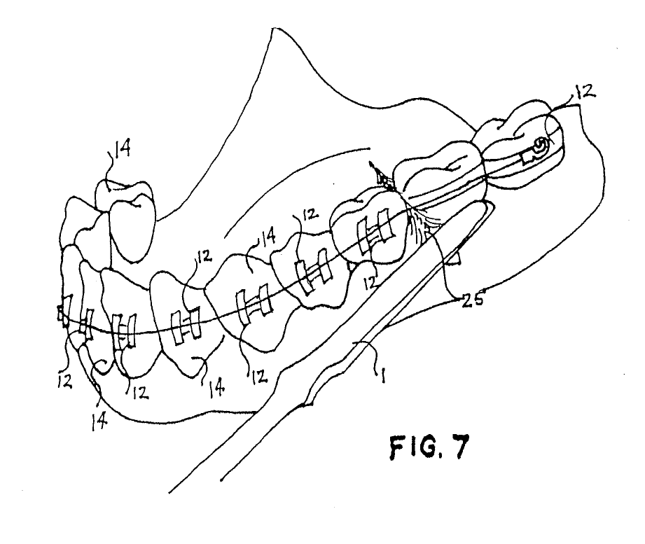

The cleaning technique with the brush 25 fitting between wire 13 and teeth 14 is shown in FIG. 7.

In an alternate embodiment illustrated in FIGS. 8 through 10, the bristle head of the orthodontic toothbrush is removable so that it can be replaced with a more conventional bristle head 30 for cleaning the lingual side of the teeth. In addition, one conventional vertical position is shown along with two other alternate positions at 45 degree angles to handle 1, in addition to the straight (in-line) vertical position. In all positions, the bristle head 30 remains collinear with handle 1.

To accomplish these goals, handle 1 is fitted with a short engagement rod 32 with three dimples 33 (two are shown) spaced at 45 degrees apart along the periphery of rod 32. This fits into segmented collar 31 with latch segment 34 and engagement nib 35 at the end of bristle head 30. Both the orthodontic bristle head 2 and the conventional bristle head 30 may be fitted with these mating features, although only the conventional bristle head 30 is illustrated in FIG. 8.

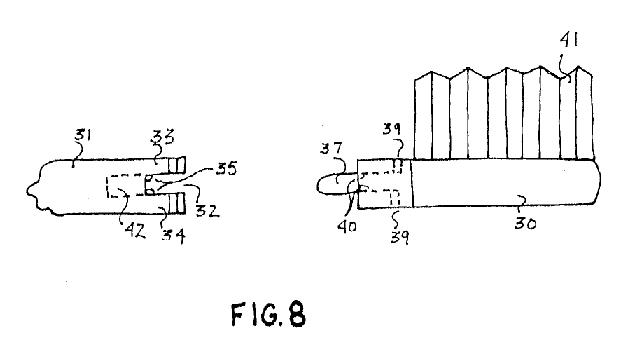

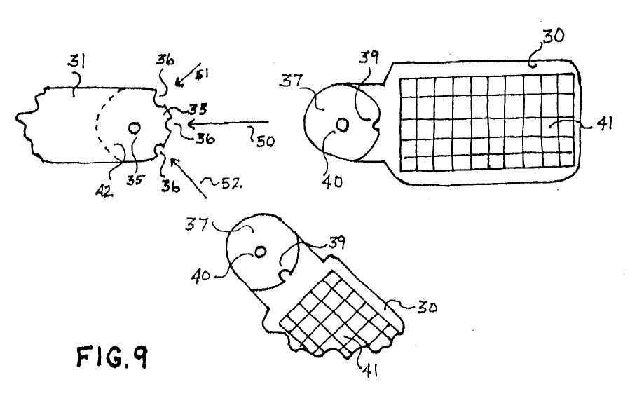

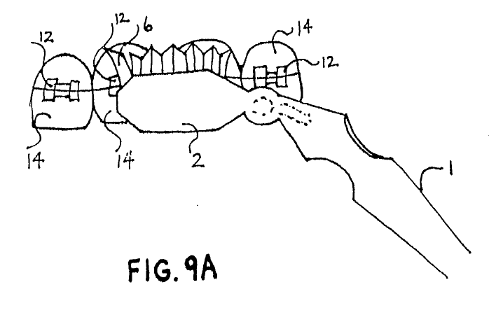

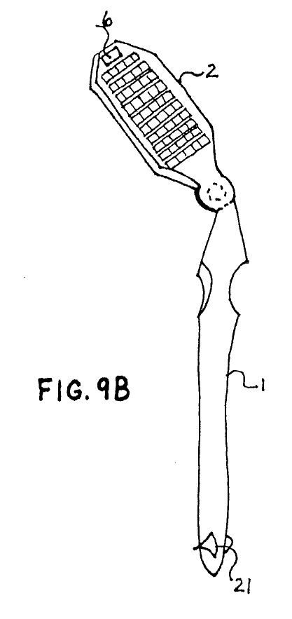

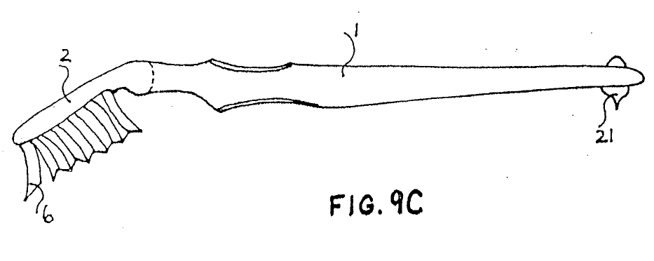

FIG. 9, which is an end view of bristle head 30, shows the engagement apparatus more clearly.

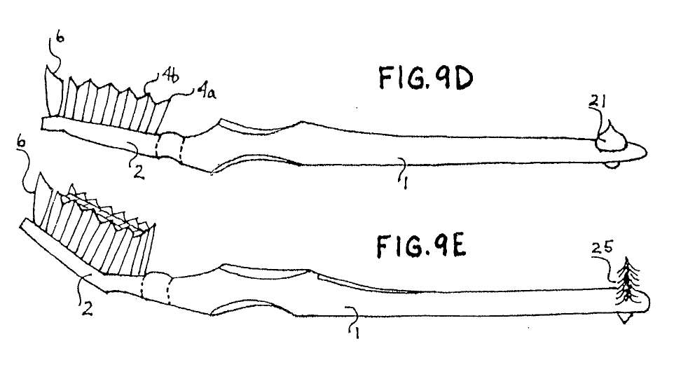

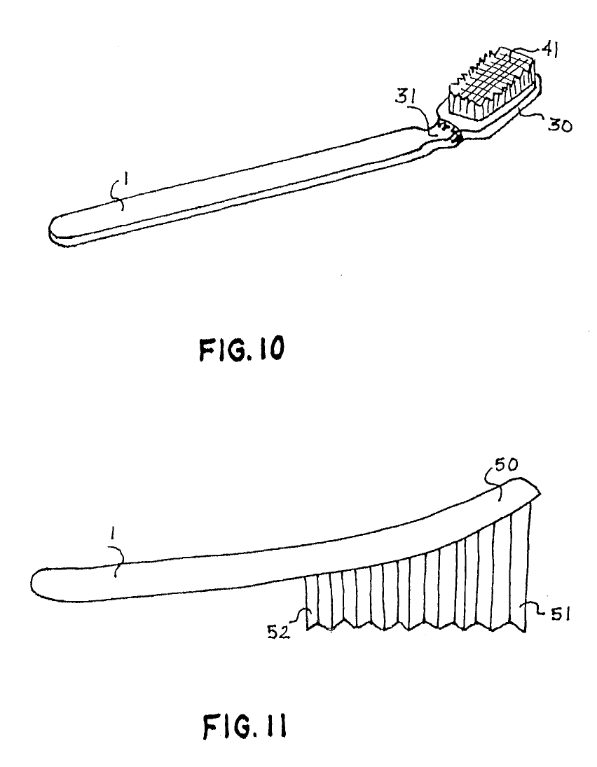

FIG. 10 is a distal end view of a toothbrush with these rotatable features, showing three permissible positions A, B and C. Bristle head 30 is shown rotated 45 degrees clockwise relative to the position of handle 1. Phantom views show the aligned position at B and the counterclockwise position at A. Detailed mold design and selection of appropriate molding resin characteristics determine the forces required for bristle head replacement and rotation

FIG. 11 shows a further alternate embodiment using a bristle head 50 with continuously curved bundles of bristles. Bristle bundle lengths vary uniformly from the shortest 52 to those at the distal end 51 which are the longest. The variation of bristle bundle lengths from the proximal to the distal ends follows a smooth curve 53.

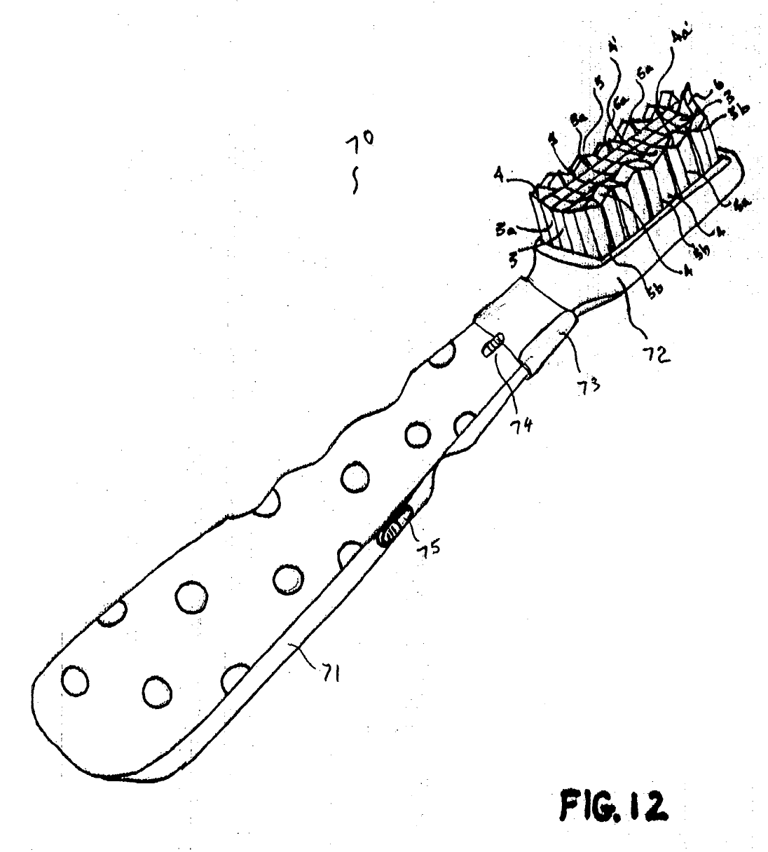

FIGS. 12-22 describe an optional embodiment for an electronic toothbrush which operates movement of the bristle head with a vibrating or other directional motion, wherein the bristle head of an electronic toothbrush can help utilize this style of bristles in an oscillatory, rotating, stroke-like or vibrating motion to remove debris around the orthodontic braces, including brackets and bands, and the teeth.

FIG. 12 shows this optional embodiment for an electronically operated orthodontic toothbrush and FIG. 13 shows the bristle head portion of the electronically operated orthodontic toothbrush as in FIG. 12.

In FIG. 13 the orthodontic toothbrush of the present invention cleans orthodontic braces and the teeth to which they are attached, with the aforementioned special configuration of pairs of tufts at varying heights, wherein two adjacent pairs of tufts together form a peak separable by a gap between each tuft of each pair of tufts, to maximize both reach and divergence of the cleaning surfaces of the tooth brush upon the respective braces and underlying teeth.

FIGS. 12 and 13 illustrate the general configuration of an electronic toothbrush 70 of this invention with handle housing 71 containing motor, mechanisms, battery and electronics, brush head 72, switch actuator 75, coupling collar 73, and latch lock 74. These views just show a generic version of coupling collar 73 which is shown to have three variations in later drawings. The basic configuration allows for replacement of batteries, however by using a large capacity lithium battery, a disposable version with sealed housing 71 can be built.

Three distinctly different oscillatory motions are supported by this electronic toothbrush simply by changing head assemblies.

For example, FIG. 14 illustrates the movement supported by head 80 which axially oscillates in the direction shown by arc 81.

FIG. 15 illustrates the pivoting oscillatory motion of head 85 along arc 86.

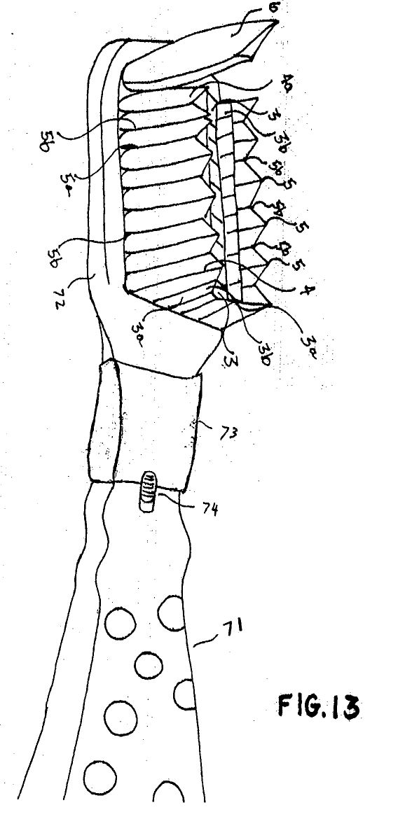

FIG. 16 illustrates the axial stroke 88 supported by head assembly 87.

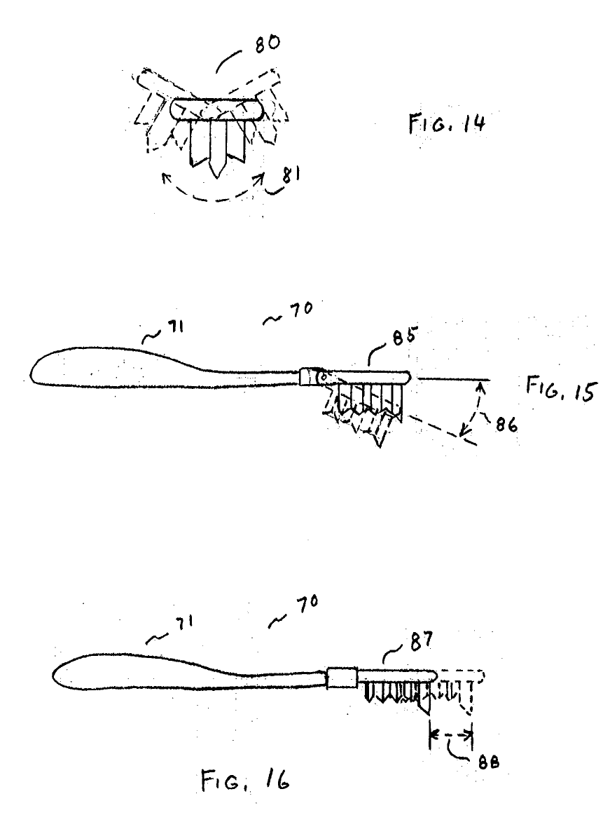

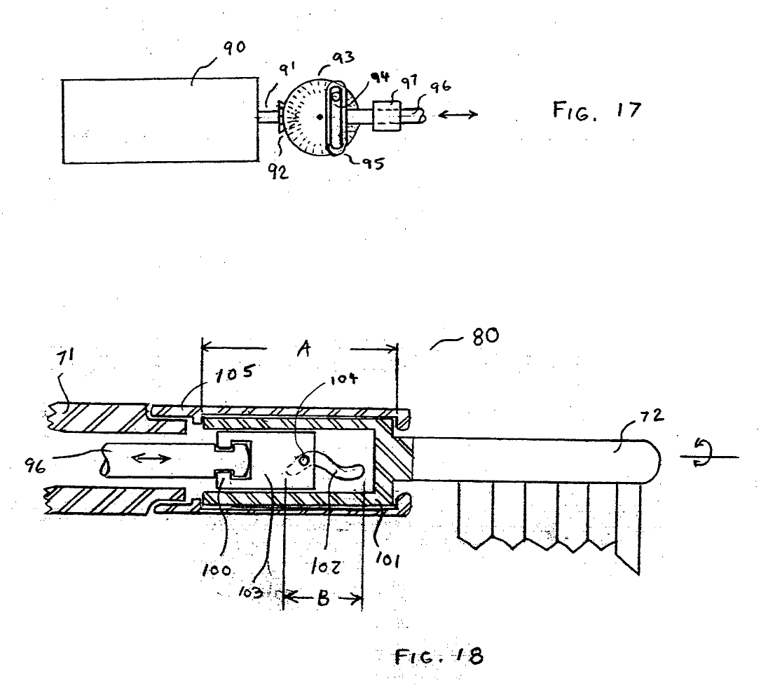

All three motions are derived by mechanisms in the head assemblies which extend or convert the reciprocating motion derived from the motor driven mechanism of FIG. 17. Rotary motor 90, which is preferably a permanent magnet DC motor, has output shaft 91 attached to bevel gear pinion 92. Pinion 92 engages large bevel gear 93 forming a right angle speed reducing drive. Drive pin 94 is eccentrically attached to bevel gear 93 and engages Scotch yoke 95 converting rotary motion to reciprocating motion of output shaft 96. Although a round crossection can be used, a square or hexagonal crossection and matching internal aperture of linear bearing 97 will resist twisting of shaft 96 resulting in less vibration.

FIG. 18 shows the internal structure of head assembly 80 for achieving axial brush head 72 oscillations. Head assembly 80 includes bristle head 72 attached to rotatable cylinder 101, coupling sleeve 105, and captive piston 103. Coupling sleeve 105 attaches to handle 71 extension and latches with latch lock 74 (FIG. 12); it also keeps cylinder 101 from reciprocating linearly while permitting rotation. Piston 103 has pin 104 which engages a spiral slot 102 on each side of cylinder 101. This keeps it captive. A quarter-turn coupling 100 engages piston 103 to reciprocating shaft 96 end (with the same motion coupling sleeve 105 to the distal end of handle 71). Once coupled, the operation is such that linear movement of shaft 96 and attached piston 103 will cause cylinder 101 to rotate in an oscillatory motion by virtue of pin 104 sliding in spiral slots 102.

FIG. 19 shows the internals of head assembly 85 for imparting pivoting oscillations. This consists of coupling sleeve 110 with pivot pin 111 attaching bristle head 72. Piston 113 has quarter-turn coupling 100 and is attached to semi-flexible member 112 which causes oscillatory tilting of bristle head 72 by acting as a “push-pull” drive tape upon linear oscillation of shaft 96.

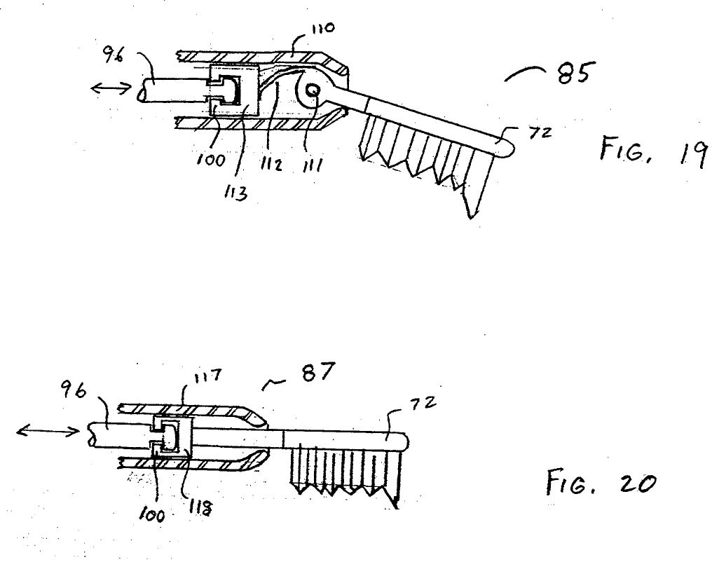

FIG. 20 shows the operation of head assembly 87 which imparts linear oscillatory strokes to bristle head 72. The linear oscillations of shaft 96 are simply extended to head 72 via piston 118 and coupling 100, all within coupling sleeve 117.

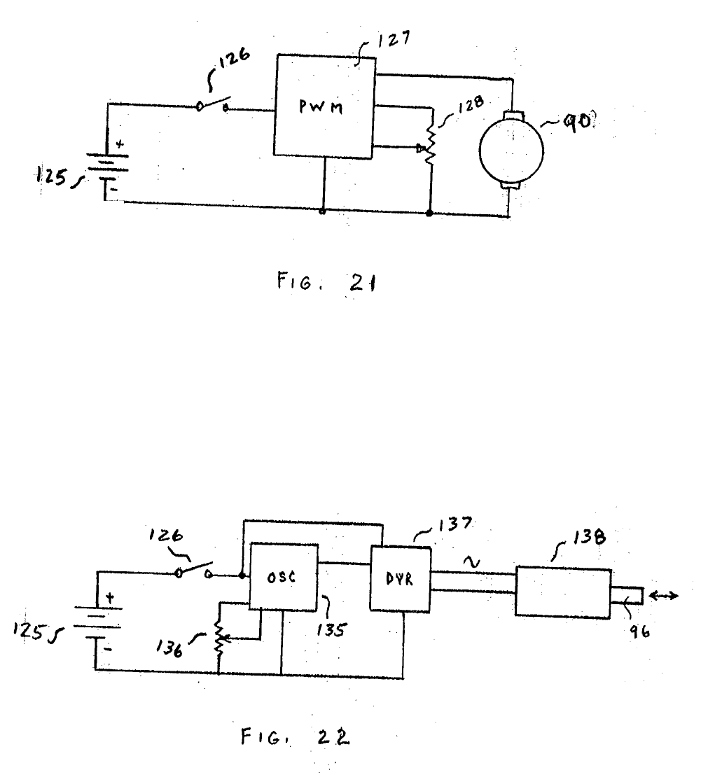

FIG. 21 is a block diagram of the circuitry relating to the electronic toothbrushes of this invention Battery 125 supplies power to pulse width modulation speed control 127 which drives motor 90. Potentiometer 128 controls the duty cycle which determines the motor 90 speed (given a fixed load). A knob (not shown) penetrates handle housing 71 to permit adjustment.

In an alternate embodiment, motor 90 and the mechanism shown in FIG. 17 can be replaced with voice-coil actuator 138 which permits smooth operation over a very wide range of oscillatory frequencies since no conversion from rotary to reciprocating motion is required. Here battery 125 and switch 126 power an oscillator 135 and a driver 137 which supplies AC at the desired frequency to actuator 138. Potentiometer 136 is used to vary the oscillator frequency which is directly translated into reciprocating motion of output shaft 96.

In yet another embodiment, a head assembly supporting a compound motion of bristle head 72 incorporating the rotary motion shown in FIG. 14 with the linear stroking shown in FIG. 16 is defined.

It is a modification of head assembly 80 best understood by reference to FIG. 18. In FIG. 18, cylinder 101 is constrained in linear movement (stroking) relative to coupling sleeve 105 by front and back ridges spaced distance A apart. If dimension A is extended a small amount beyond the length of cylinder 101 while dimension B, the length of the spiral slot, is decreased by the same amount, the modification is implemented. By assuming the same peak-to-peak movement of shaft 96, it will be appreciated that bristle head 72 will stroke linearly for part of the stroke then rotate in one direction, then on the reverse stroke, head 72 will stroke linearly in the opposite direction and then rotate in a reverse direction.

To enhance the compound motion aspect, the mechanism of FIG. 17 (or the stroke of voice coil actuator 138) should be designed to provide a longer driving stroke since only part of each stroke movement is devoted to either linear movement or to the rotation of bristle head 72.

It is further noted that other modifications may be made to the present invention without departing from the scope of the invention.

We claim:

1. An apparatus for supplying reciprocating motion to operate a toothbrush head motion mechanism of an electric toothbrush comprising:
a battery power source, an oscillator, a user operable potentiometer, a driver, and a voice-coil actuator,
wherein said potentiometer is user set to vary the output frequency of said oscillator over a broad range, thereby directly controlling a predetermined motion frequency of said toothbrush head motion mechanism.

2. A brush head motion mechanism of an electric toothbrush providing an oscillatory tilting cyclical rocking motion of a toothbrush head comprising:
a converter converting an input linear reciprocating motion of a piston within a sleeve via a semi-flexible push-pull drive tape member attached to said piston and to said bristle head, in a position eccentric to a fixed axle on said sleeve, to which said brush head is pivotally attached.

3. A brush head motion mechanism of an electric toothbrush providing compound oscillatory motion of said brush head comprising:
a motor providing both linear stroking and rotation wherein said compound motion is generated by a piston reciprocating linearly within a sleeve rigidly attached to said brush head and coupled to said piston via pins extending radially from said piston being engaged in spiral slots in the walls of said sleeve also,
wherein the linear length of said spiral slots is shorter than a total stroke length of said piston and further,
wherein said sleeve is guided in its said compound motion by a concentric fixed outer sleeve of length equal to the said total stroke length of said piston.

4. An orthodontic toothbrush for cleaning braces, including brackets and bands, adhered to teeth while simultaneously cleaning the teeth, wherein each said tooth has a bracket or band which protrudes from the surface of a tooth, wherein further said bracket and band is connected by a spanning archwire, wherein further the toothbrush has a longitudinally extending handle attached to a tooth cleaning head having a plurality of bristles extending upward from a bottom within said bristle head to a top, said tooth brush comprising:
a plurality of adjacent pairs of tufts of bristles extending upwardly from said bristle head in a plurality of longitudinally disposed rows, said pairs of tufts comprising bristles projecting upward parallel to one another and wherein
said pairs of tufts having bristles having top-to-bottom lengths, said lengths varying to comprise a contoured tooth contact surface, said tooth contact surfaced being comprised of the tops of said plurality of respective bristles;
said pairs of tufts comprising discrete separable aggregates of bristles; said separability comprising gaps splitting upon pressure from contact with teeth between respective adjacent pairs of tufts, said tuft gaps splitting and running vertically along the top-to-bottom length of the adjacent pairs of tufts, said split-apart tuft pairs comprising bristles urged into varying directions according to tuft by pressure of contact with teeth, said bristles of differing tufts being separately and differentially insertable into gaps between teeth and into spaces between orthodontic brackets and tooth surfaces;
said contoured tooth contact surface comprising a depressed center comprised of inner rows of tufts disposed on said bristle head, said inner bristles comprising relatively shortest bristles; and
said contoured tooth contact surface comprising upwardly and outwardly sloped medial rows of tufts disposed on said bristle head, said medial bristles comprising bristles relatively longer than said shortest inner bristles, said medial rows of tufts being disposed laterally outward on both sides of said inner rows of tufts; and
said contoured tooth contact surface comprising an elevated perimeter comprised of outer rows of tufts disposed on said bristle head, said outer bristles comprising relatively taller bristles; and wherein
said inner rows of tufts comprise a plurality of tooth contact surface facets, said facets corresponding to individual tufts and said facets comprising an inner portion of said contoured tooth contact surface; and wherein
said bristle head comprises a distal end having at least one distal tuft therein, said at least one distal tuft being taller than the perimeter, medial and inner tufts in contact with said distal tuft to assist in getting brush access to the band attachments and brace fasteners in the posterior region of the mouth; and wherein
said combination of short, medial, tall and at least one tallest bristle(s) configured such that each pair of tufts contact adjacent pairs of tufts along adjacent contact surfaces and each pair of tufts has said split gaps therebetween, wherein said perimeter bristles comprise a tooth contact surface having said plurality of peaks.

5. The orthodontic toothbrush as in claim 4 further comprising a friction inducing gripping surface along the handle.

6. The orthodontic toothbrush as in claim 4 wherein said toothbrush head is removable and replaceable by a conventional toothbrush head.

7. The orthodontic toothbrush as in claim 6 wherein said handle is joinable to said bristle head, wherein said handle includes an insertion member insertable within a socket within said bristle head.

8. The orthodontic toothbrush as in claim 7 wherein said bristle head includes at least one mating surface engageable with a corresponding mating surface of said handle.

9. The orthodontic toothbrush as in claim 4 wherein said toothbrush head is rotatable to a position from zero to about forty-five degrees off of its longitudinal axis.

10. The orthodontic toothbrush as in claim 4 further comprising an interchangeable conical tooth stimulator member at a proximal end of said handle which said proximal end is opposite to a distal end of said toothbrush head.

11. The orthodontic toothbrush as in claim 10 wherein said interchangeable conical tooth stimulator member is a group of bristles.

12. The orthodontic toothbrush as in claim 10 wherein said interchangeable conical tooth stimulator member is a flexible solid member.

13. The orthodontic toothbrush as in claim 4 wherein said handle is joinable to said bristle head, wherein said handle includes an insertion member insertable within a socket within said bristle head.

14. The orthodontic toothbrush as in claim 4 wherein said bristle head includes at least one mating surface engageable with a corresponding mating surface of said handle.

15. The orthodontic toothbrush as in claim 4 further comprising an interchangeable conical tooth stimulator member at a proximal end of said handle which said proximal end is opposite to a distal end of said toothbrush head.

16. The orthodontic toothbrush as in claim 15 wherein said interchangeable conical tooth stimulator member is a group of bristles.

17. The orthodontic toothbrush as in claim 15 wherein said interchangeable conical tooth stimulator member is a flexible solid member.

18. The orthodontic toothbrush as in claim 4 further comprising a power source, said power source causing said bristle head to move in at least one of an oscillatory, rotating, stroke-like or vibrating motion to remove debris around the orthodontic braces, including brackets and bands, and the teeth.

19. The orthodontic toothbrush as in claim 18 wherein said power source further comprises a rotary permanent magnet DC motor having an output shaft engagable with a speed reducing drive, converting rotary motion to reciprocating motion of said output shaft.

20. The orthodontic toothbrush as in claim 18 wherein said toothbrush head includes a partial turn assembly causing linear movement of a shaft and an attached piston causing said bristle head to rotate in an oscillatory motion by means of a pin sliding in spiral slots.

21. The orthodontic toothbrush as in claim 18 wherein said bristle head tilts by pivoting oscillations, caused by a piston attached to a semi-flexible member, said semi-flexible member causing oscillatory tilting of said bristle head by acting in a push-pull movement when said shaft is subject to linear oscillation.

22. The orthodontic toothbrush as in claim 18 wherein said toothbrush head moves in a back and forth stroke movement and a piston imparts linear oscillatory strokes to said bristle head.

23. The orthodontic toothbrush as in claim 18 wherein said power source supplies electrical power to a speed control driving a speed controlled motor.
